(19) United States
(12) Patent Application Publication
(10) Pub. No.: US 2025/0068740 A1
(43) Pub. Date: Feb. 27, 2025

(54) DEVICE-SPECIFIC FIRMWARE DISTRIBUTION

(71) Applicant: SK Hynix NAND Product Solutions Corp. (dba Solidigm), Rancho Cordova, CA (US)

(72) Inventors: Wilson Young, Burnaby (CA); Andre Silveira, Gold River, CA (US); Michal Antoniewski, Gdansk (PL)

(21) Appl. No.: 18/237,203

(22) Filed: Aug. 23, 2023

(51) Int. Cl. G06F 21/57; G06F 21/60; G06F 21/64; G06F 21/73

(52) U.S. Cl. CPC G06F 21/572; G06F 21/602; G06F 21/64; G06F 21/73

(57) ABSTRACT

In accordance with some aspects of the present disclosure, a method for authenticating a device associated with an immutable unique device identification to install firmware on the device is disclosed. The method includes retrieving, using processing circuitry at the device, the unique device identification, receiving, at the device, a package including signed data based on at least one target unique device identification and based on the firmware, authenticating, using the processing circuitry, the device based on the signed data, and in response to authenticating the device, using the processing circuitry to cause the firmware to be installed on the device.

### TECHNICAL FIELD

The present disclosure is directed to methods and systems for authenticating a device associated with a unique device identification to install firmware.

### SUMMARY

In accordance with the present disclosure, methods and systems are provided for authenticating a device associated with a unique device identification (ID) to install firmware on the device. The methods and systems disclosed herein may provide secure and device-specific firmware distribution from a firmware provider to a particular recipient device based on the unique device ID.

In accordance with some aspects of the present disclosure, a method for authenticating a device associated with an immutable unique device identification to install firmware on the device is disclosed. The method includes retrieving, using processing circuitry at the device, the unique device identification, receiving, at the device, a package including signed data based on at least one target unique device identification and based on the firmware, authenticating, using the processing circuitry, the device based on the signed data, and in response to authenticating the device, using the processing circuitry to cause the firmware to be installed on the device.

In some embodiments, the package also includes the firmware. In some embodiments, the method also includes decrypting the signed data and hashing a combination of the firmware and the unique device identification, wherein the at least one target unique device identification includes a single target unique device identification, the decrypted signed data includes a hash of a combination of the firmware and the single target unique device identification, and authenticating the device based on the signed data includes comparing the hash of the combination of the firmware and the target unique device identification with the hash of the combination of the firmware and the unique device identification. In some embodiments, the signed data is encrypted and decrypted using a digital signature scheme. In some embodiments, the method also includes decrypting the signed data and identifying the at least one target unique device identification from the decrypted signed data, wherein authenticating the device based on the signed data includes comparing the at least one target unique device identification to the unique device identification. In some embodiments, the package also includes data indicative of at least one of a type of the firmware or a configuration of the device.

In accordance with some aspects of the present disclosure, a device includes processing circuitry configured to retrieve an immutable unique device identification, receive a package including signed data based on at least one target unique device identification and based on the firmware, authenticate the device based on the signed data, and in response being authenticated, use processing circuitry to cause the firmware to be installed on the device.

In some embodiments, the package also includes the firmware, wherein the processing circuitry is also configured to receive a package including firmware. In some embodiments, the at least one target unique device identification includes a single target unique device identification, and the signed data includes a hash of a combination of the firmware and the single target unique device identification, wherein the processing circuitry is also configured to decrypt the signed data, hash a combination of the firmware and the unique device identification, and authenticate the device based on comparing the hash of the combination of the firmware and the target unique device identification with the hash of the combination of the firmware and the unique device identification. In some embodiments, the signed data is encrypted using a digital signature scheme, wherein the processing circuitry is also configured to decrypt the signed data using a digital signature scheme. In some embodiments, the processing circuitry is also configured to decrypt the signed data, identify the at least one target unique device identification from the decrypted signed data, and authenticate the device based on comparing the at least one target unique device identification to the unique device identification. In some embodiments, the package also includes data indicative of at least one of a type of the firmware or a configuration of the device, wherein the processing circuitry is also configured to receive a package including data indicative of at least one of a type of the firmware or a configuration of the device.

In accordance with some aspects of the present disclosure, a method for distributing firmware to at least one target device is disclosed. The method includes determining for each of the at least one target device, a respective target unique device identification, generating at least one package for the at least one target device, each of the at least one package including respective signed data based on the at least one target unique device identification and on the firmware, and communicating the at least one package and the firmware to at least the at least one target device.

In some embodiments, each of the at least one package also includes the firmware. In some embodiments, determining each respective target unique device identification includes retrieving each respective target unique device identification from each respective target unique device, and generating each of the at least one package includes hashing a combination of the firmware and a respective one of the at least one target unique device identification. In some embodiments, the method also includes encrypting each of the at least one package. In some embodiments, encrypting each of the at least one packages includes encrypting each of the at least one packages using a digital signature scheme. In some embodiments, each of the at least one package also includes data indicative of at least one of a type of the firmware or a configuration of the device.

In some embodiments, the method is provided with a memory and processing circuitry (e.g., a storage device) that are communicatively coupled to each other. In some embodiments the system can be distributed between a storage device and another device separate from the storage device (e.g., a host device, such as a storage controller device), such as where the host device provides processing circuitry to implement at least some of the functionality described herein. In some embodiments, the processing circuitry receives write requests and signals from the host device. In some embodiments, the processing circuitry selects to write data associated with the write request to the first memory portion based on a characteristic of the data stream when each portion of the memory is available to be written to. The signal received by the processing circuitry may include data such as the characteristic of the data stream which is used by the processing circuitry in the selection to write the data associated with the write request to the first memory portion. The processing circuitry then writes the data associated with the write request to the first memory portion.

### BRIEF DESCRIPTION OF THE DRAWINGS

The following description includes discussion of figures having illustrations given by way of example of implementations of embodiments of the disclosure. The drawings should be understood by way of example, and not by way of limitation. As used herein, references to one or more “embodiments” are to be understood as describing a particular feature, structure, and/or characteristic included in at least one implementation. Thus, phrases such as “in one embodiment” or “in an alternate embodiment” appearing herein describe various embodiments and implementations, and do not necessarily all refer to the same embodiment. However, they are also not necessarily mutually exclusive.

FIG. 1 shows a local device configured to receive firmware from a firmware provider, in accordance with some embodiments of the present disclosure;

FIG. 2 shows a storage device and a host configured to install authenticated firmware on the storage device, in accordance with some embodiments of the present disclosure;

FIG. 3 shows a flowchart of illustrative steps for authenticating a device to install firmware, in accordance with some embodiments of the present disclosure;

FIG. 4 shows a flowchart of illustrative steps for authenticating a device to install firmware, in accordance with some embodiments of the present disclosure; and

FIG. 5 shows a flowchart of illustrative steps for distributing firmware to a unique device, in accordance with some embodiments of the present disclosure.

### DETAILED DESCRIPTION

Firmware is software that links physical hardware and operational software systems. Firmware may be installed directly onto an electronic device (e.g., a computer, storage device, telecommunication device, battery pack, printer, camera, sensor, electronic tool and equipment, any other suitable electronic device, or any combination thereof) during manufacturing. Later, firmware updates and other firmware modifications may be installed such as for instantiating dynamic updates, debugging (e.g., identifying or resolving functional issues), replacing or fixing older firmware releases, providing new functionality, removing existing functionality, any other desired function, or any combination thereof.

Some firmware may be developed by a device manufacturer or other provider of technical support services for a device in response to feedback (e.g., through user submissions, device logs, internal testing, any other solicitation, or any combination thereof) related to problems associated with a device. As part of the triaging that might take place in order to identify and fix underlying issues, the provider may install debugging firmware that is specifically designed for those issues particular to the device. However, a simple and universal broadcast of a debug firmware update has downsides, e.g., if only one or a handful of devices are affected, other unaffected devices may also install the universally broadcasted firmware and then experience new issues.

To resolve this limitation, firmware may be specifically distributed by a firmware provider (e.g., a software developer, a hardware developer, a software vendor, a hardware vendor, a cloud platform, a local host, a remote host, any other suitable storage of firmware, or any combination thereof) to one or more target devices using an authentication procedure. For security and specificity of distribution, the receiving device may only install the firmware after a successful authentication. Authenticating such a target device for receiving a particular firmware may include sharing, with the firmware, data particular to that target device.

Such an authentication may resolve security concerns associated with firmware distribution. Because firmware may involve the adding of tools, solving of issues, asserting of memory configurations, and/or other fundamental processes, installing firmware makes a device vulnerable to attack. For example, a firmware package may require a relaxation of security measures or a logging of security information. If such a firmware package were to be externally replicated, then a malicious entity might be able to distribute such malicious firmware to target machines and exploit those machines after the replicated firmware was installed thereon. Devices may be protected from such attacks by an internal authentication process that cannot be externally replicated and only permits the installation of firmware that passes the authentication.

In accordance with the present disclosure, methods and systems are provided for authenticating a device associated with a unique device ID to install firmware on the device. As used herein, the terms authenticating, authentication, authenticate, and related versions thereof refer to at least determining that a particular device receiving firmware is specifically targeted by the provider of the firmware to install the firmware onto the device.

In some embodiments, a firmware provider may send firmware to a device, or a device may request firmware from a firmware provider. The firmware provider may determine that particular firmware may only be installed on a targeted device that has been authenticated. To make such an authentication secure, it may require mutual verification (e.g., by the firmware provider and the device) of the device's unique device ID. When it is needed, this unique device ID may be generated by the device and/or it may be retrieved from memory storage including an existing unique device ID. For example, if the unique ID is generated by the device, it may subsequently be retrieved by the device for use in an authentication.

For example, a manufacturer may assign each of its manufactured devices with a unique ID (e.g., a serial number or other unique identifier) that may be hardcoded at the time of manufacture. Later, as part of a secure firmware distribution process, the manufacturer may refer to that previously generated unique ID. However, if the privacy of old unique device IDs is compromised, then the device may instead generate a new unique device ID that is derived from the previously generated unique ID. The device may then make the new unique ID retrievable by a firmware provider (e.g., through a direct communication, data log, telemetry dump, or any other suitable sharing of information). Through such a procedure, a firmware provider can prescribe a unique ID-based authentication that only distributes firmware to one or more target devices associated with the particular firmware.

Having determined the unique device ID for the target device, the firmware provider may securely and specifically distribute firmware for installation. In some embodiments, the firmware provider creates and communicates a firmware package including signed data based on the unique device ID and based on the firmware. The firmware package also includes a requirement for authentication prior to installation. Because the signed data (e.g., including a hash of at least the unique device ID) contains unique information corresponding to a targeted device, no untargeted device can complete an authentication and install the firmware. When such a targeted device receives the signed package, it may perform the authentication based on the signed data (e.g., by determining that a first hash of at least the target unique device ID that is in the signed data matches a second hash of at least the device's unique device ID that is generated by the device). In response to such a successful authentication, the targeted device may install the firmware thereon. If an untargeted device were to receive the same firmware package, it would perform an unsuccessful authentication and therefore not install the firmware.

It is often required to transmit firmware to multiple target devices (e.g., devices with identical hardware models, identical hardware subsystems, identical operating systems, or identical software subsystems, devices that are co-located, devices with a shared owner, devices with any other shared characteristic, otherwise related devices, or any combination thereof). To securely and specifically distribute firmware to multiple target devices, without affecting untargeted devices, a firmware provider may create a firmware package including signed data based on multiple target unique device IDs and a requirement for authentication prior to installation. When each targeted device receives such a package, it may access the multiple target unique device IDs (e.g., by decrypting the signed data) and perform the authentication by determining that one of the multiple target unique device IDs matches the device's unique device ID. In response to each successful authentication, each common device may install the firmware thereon.

Based on the sensitivity of the firmware package contents, including the firmware and the unique device ID, the device and the firmware provider use cryptographic operations and related operations to secure the authentication process. The firmware provider may create the signed data using an encryption operation including a digital signature scheme (which may use asymmetric or symmetric encryption, using at least one of a private or a public key) and may conceal the unique device ID using a hash algorithm. The device may process the signed data using a decryption operation including the digital signature scheme. The underlying cryptography for a digital signature scheme may include asymmetric encryption, where the package is encrypted using a private key and decrypted using a public key. The digital signature scheme may include other cryptographic techniques in place of or in addition to the asymmetric encryption, including padding of the signed data. The underlying digital signature scheme may also include symmetric encryption (e.g., by utilizing one or more pre-determined keys that may be installed on a device at the time of manufacture or during operation in the field). The firmware provider may determine a target device's unique device ID using a decryption operation. These processes maintain confidentiality of the unique device ID, the signing process, and other proprietary data or operations.

In some embodiments, the firmware provider may also include, in the package including signed data, firmware, data indicative of the type of firmware that is being distributed (e.g., a firmware key, debug key, release key, any other suitable key, file size, file date, file creator, any other suitable file information, any other firmware descriptor, any other debug descriptor, or any combination thereof), and/or data indicative of a configuration of the target device (e.g., bits burned into fuses, SKU information, runtime settings, any other device configuration, or any combination thereof). This data may be included in another verification step (e.g., confirm the proper firmware key) during authentication. It may otherwise serve to augment logs of sequential firmware updates, ensure the compatibility of new firmware with prior installations, improve a provider's or user's visibility into debug processes, further verify that the proper firmware has been received by the target device, or perform additional functions.

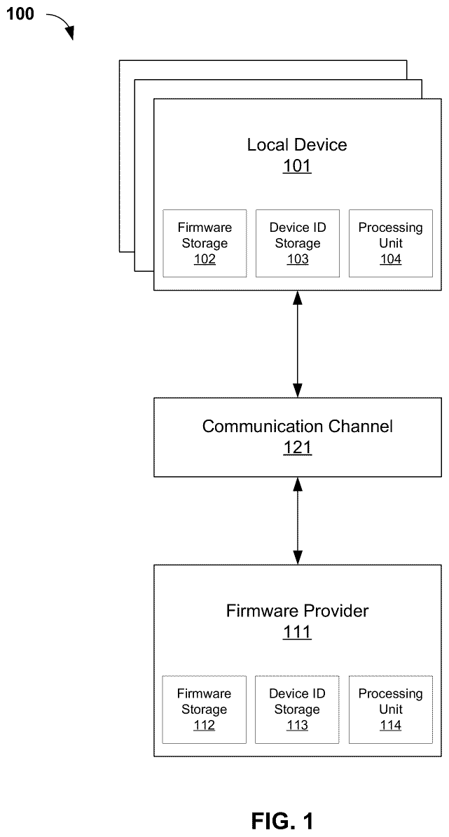

The subject matter of this disclosure is further discussed with reference to FIGS. 1-5.

FIG. 1 shows a system 100 for a local device 101 to receive firmware from a firmware provider 111 over a communication channel 121, in accordance with some embodiments of the present disclosure. Local device 101 (e.g., a single computer, hard drive, server, local host, or any other suitable device) includes firmware storage 102, device ID storage 103, and processing unit 104. Firmware provider 111 (e.g., a single computer, hard drive, server, software repository, network-attached storage, storage area network, cloud archive, any other suitable provider, or any combination thereof) includes firmware storage 112, device ID storage 113, and processing unit 114. Local device 101 may connect to firmware provider 111 via communication channel 121. In some embodiments, communication channel 121 is implemented via a network communication protocol (e.g., LAN, MAN, WAN, DHCP, DNS, FTP, HTTPS, IP, LDAP, MAC, POP, PPP, SMTP, SNMP SSH, TCP, TLS, UDP, any other suitable protocol, or any combination thereof).

Local device 101 includes a unique device ID that may be stored in both of device ID storage 103 and device ID storage 113. In some embodiments, device ID storage 113 includes one or more target unique device IDs (e.g., stored as a binary large object or any other suitable list). In some embodiments, local device 101 is configured to generate and/or retrieve its own unique device ID using processing unit 104, and this unique device ID is determined by firmware provider 111 over communication channel 121 (e.g., by a log retrieval, by a direct communication, by any other write to a repository that can be accessed by the firmware provider, by any other suitable communication, or by any combination thereof). In some embodiments, local device 101 may derive its unique device ID from existing device-specific information stored thereon. In some embodiments, the determination of a respective unique device ID by the firmware provider 111 may include a cryptographic operation (e.g., a decryption). Processing unit 104 may be configured to create a hash of at least the unique device ID stored in device ID storage 103. Processing unit 104 may also be configured to determine that firmware provided by firmware provider 111 requires authentication prior to installation.

Each of device ID storage 103 and device ID storage 113 may be persistent and immutable memory. The unique device ID for local device 101 may be permanently stored on such persistent and immutable memory. Therefore, the unique device ID may be persistent and immutable.

In some embodiments, firmware provider 111 may communicate with multiple local devices 101, each with a respective unique device ID. Multiple such local devices 101 may be authenticated if each one of the devices has a respective unique device ID that matches a target unique device ID stored in device ID storage 113. For example, a list of target unique device IDs may be communicated to multiple local devices 101 (e.g., as a binary large object or any other suitable list), including as part of a digital signature or as part of signed data included in a package.

Processing unit 114 is configured to at least retrieve firmware from firmware storage 112, determine and store at least one target unique device ID corresponding to the firmware in device ID storage 113, generate a package including signed data based on the firmware and the at least one target unique device ID, and communicate the resulting package to local device 101. In some embodiments, processing unit 104 is configured to at least receive the signed package from firmware provider 111 and verify the digital signature thereon by matching the target unique device ID of the signature to the device's unique device ID as stored in device ID storage 103. For example, the digital signature may be verified by determining that two hashes of at least the unique device ID, which are respectively created by the firmware provider 111 and the device 101, match each other. In some embodiments, such hashes may include a combination of the unique device ID and the firmware. In some embodiments, the digital signature may also include information particular to the type of firmware (e.g., a debug key) and/or a configuration of the target device (e.g., bits burned into fuses, SKU information, and/or runtime settings). In response to a successful unique device ID verification, processing unit 104 is configured to authenticate local device 101 and cause the firmware to be installed on the device.

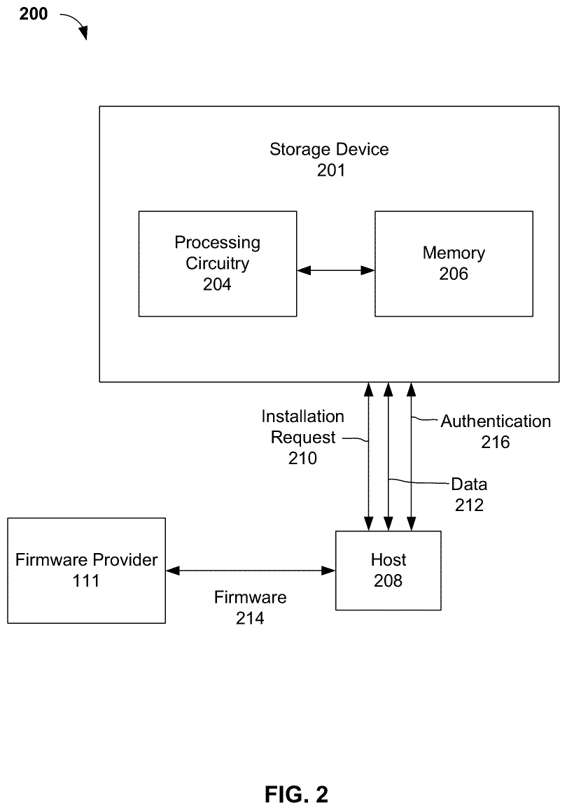

FIG. 2 shows a system 200 for operating storage device 201 (e.g., a solid-state drive), in accordance with some embodiments of the present disclosure. For example, storage device 201 may be included within local device 101. Storage device 201 includes processing circuitry 204 and memory 206. In some embodiments, processing circuitry 204 may include a processor or any suitable processing unit. In some embodiments, memory 206 may be non-volatile memory. It will be understood that the embodiments of the present disclosure include, but are not limited to, the use of a solid-state drive (SSD). For example, in some embodiments, the storage device 202 may include a hard disk drive (HDD) device in addition to or in place of an SSD. In some embodiments, system 200 includes a host 208 (e.g., a storage controller device), which communicates with the storage device 201.

In some embodiments, the processing circuitry 204 is configured to at least send and receive installation requests 210, data 212, and authentication 216 from host 208. Data 212 may include a unique device ID, a response to installation request 210, a request to receive firmware 214, an authentication 216, any other suitable data, or any combination thereof. In some embodiments, firmware provider 111 may determine that authentication 216 is required for executing installation request 210 (e.g., a debug firmware installation request), and firmware provider 111 therefore signs firmware 214 with data based on at least a target unique device ID corresponding to storage device 201. In response to receiving firmware 214 that is signed with data based on at least a target unique device ID, processing circuitry 204 may be configured to generate its own data based on the unique device ID of storage device 201 and to compare that generated data to the signed data. For example, both of those data may include a unique device ID or may include a hash of at least a unique device ID. Processing circuitry 204 may then determine that both of those data match, thereby completing authentication 216. In response to completing authentication 216, processing circuitry 204 and/or host 208 may cause firmware 214 to be installed on storage device 201. In some embodiments, the package including firmware 214 may also include information indicative of a particular property of the firmware 214.

In some embodiments, the unique device ID of storage device 201 may be stored in memory 206. This memory 206 and the unique device ID stored therein may be persistent and immutable. In some embodiments, the processing circuitry 204 receives installation request 210 and data 212 from both internal and external sources of the storage device 201. There may also be a temporary memory (e.g., a cache or queue) disposed within the processing circuitry 204, the temporary memory configured to store any outstanding data that is to be processed by the processing circuitry 204.

In some embodiments, firmware 214 is executable debug firmware. For example, firmware provider 111 may be an SSD manufacturer and may commit firmware 214 to one or more storage devices 201 that are operational in the field and require debugging. In some embodiments, such firmware may be particular to one or more device and may identify and/or resolve one or more operational issue of the one or more device. For example, firmware provider 111 may also include a debug key or a device key within a package that also includes firmware 214 and a unique device ID, where the debug key may indicate a function, purpose, or other characteristic of the firmware and the device key may indicate a particular configuration of the target device.

In some embodiments, storage device 201 is an SSD and firmware 214 is installed on this SSD. The SSD is a data storage device that uses integrated circuit assemblies as memory to store data persistently. SSDs have no moving mechanical components, and this feature distinguishes SSDs from traditional electromechanical magnetic disks, such as, hard disk drives (HDDs) or floppy disks, which contain spinning disks and movable read/write heads. Compared to electromechanical disks, SSDs are typically more resistant to physical shock, run silently, have lower access time, and less latency. SSDs use indirect memory addressing, which stores data into a next available physical memory address and maps the next available physical memory address to the logical memory address within an indirection table.

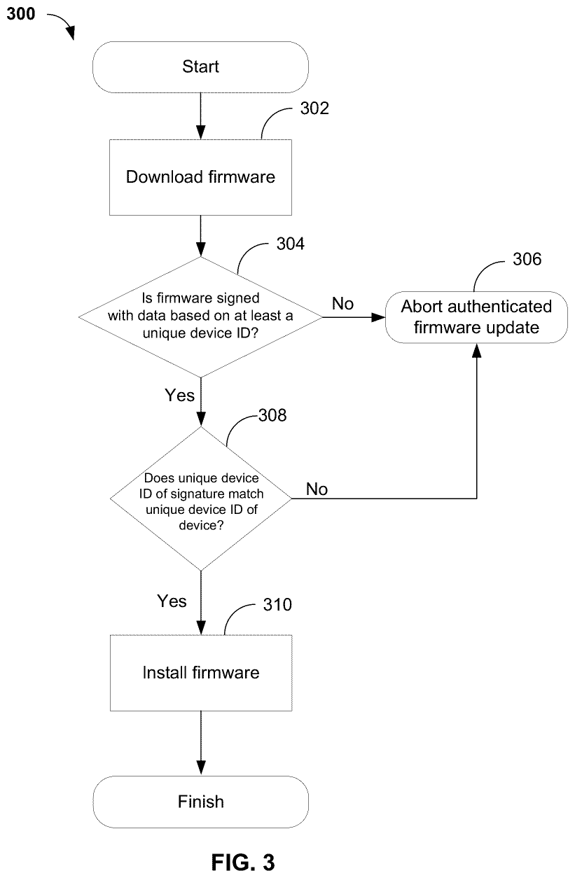

FIG. 3 shows a flowchart of a method 300 for authenticating a device associated with a unique device identification to install firmware, in accordance with some embodiments of the present disclosure. At 302, a device (e.g., local device 101 or storage device 201) downloads firmware from a firmware provider (e.g., firmware provider 111). At 304, the device determines whether the firmware is signed with data based on at least a unique device ID. At 306, if the device determines that the firmware is not signed with data based on at least a unique device ID (e.g., using processing unit 104 or processing circuitry 204), then it aborts the authenticated firmware update. However, if the device determines that the firmware is signed with data based on at least a unique device ID, then at 308 the device determines whether the unique device ID of the signature matches the unique device ID of the device. For example, the device may generate a hash of a combination of the firmware and its own unique device ID, decrypt a hash of a combination of the firmware and a target unique device ID in the firmware signature, and then compare those two hashes. If the device determines that the target unique device ID of the signature and its own unique device ID match, then at 310, the device installs the firmware thereon. However, if the device determines that those two unique device IDs do not match, then it aborts the authenticated firmware update at 306. In some embodiments, method 300 is performed on a device such that the device authenticates itself for a particular firmware installation.

Collectively, steps 304 and 308 may constitute authenticating a device to install firmware based on a unique device ID (e.g., authentication 216). In some embodiments, the firmware provider may include multiple target unique device IDs in a package that also includes firmware. In response to receiving such a package, each respective device may execute step 308 by accessing the list of multiple target unique device IDs (e.g., by decrypting the signature) and verifying that one ID among those multiple target unique device IDs matches the unique device ID of the respective device. In response to each successful verification, each device may install the firmware thereon.

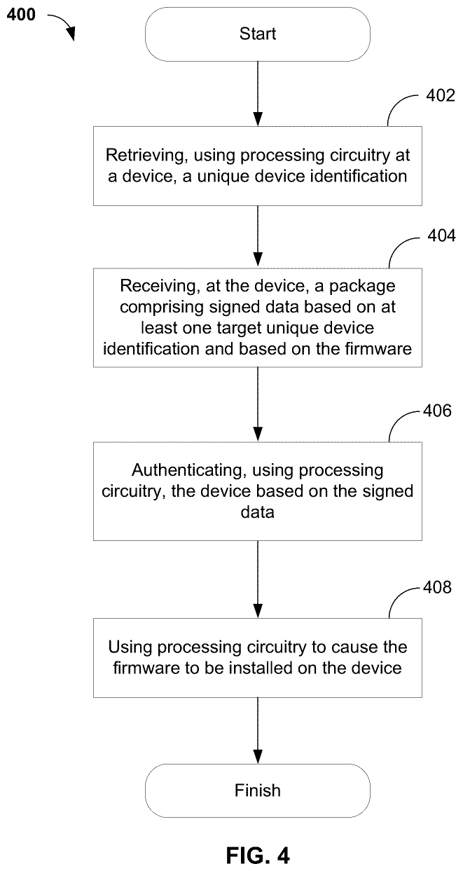

FIG. 4 shows a flowchart of a method 400 for authenticating a device associated with a unique device identification to install the firmware. At 402, a device (e.g., local device 101 or storage device 201) retrieves, using processing circuitry, a unique device identification. In some embodiments, retrieving the unique device identification also includes generating the unique device identification. At 404, the device receives (e.g., from firmware provider 111) a package including signed data based on at least one target unique device identification and based on the firmware. At 406, the device authenticates, using processing circuitry, the device based on the signed data. At 408, the device uses processing circuitry to cause the firmware to be installed on the device. In some embodiments, method 400 is performed on a device such that the device authenticates itself for a particular firmware installation.

In some embodiments, the step at 404 of receiving the package includes a first cryptographic operation (e.g., a decryption). In some embodiments, the step at 406 of authenticating the signed package includes a second cryptographic operation (e.g., a hash). In some embodiments, the decryption step uses a digital signature scheme, which may include at least one of a public key or a private key.

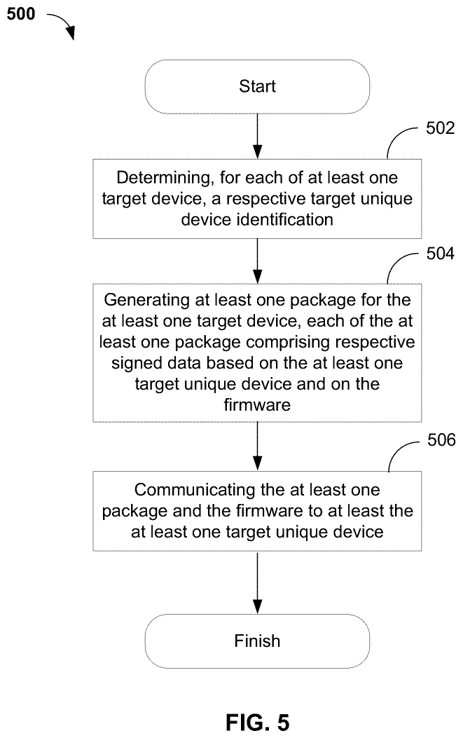

FIG. 5 shows a flowchart of a method 500 for distributing firmware to a particular unique device with a target unique device ID. At 502, a firmware provider (e.g., firmware provider 111) determines, for each of at least one target device, a respective target unique device identification. At 504, the firmware provider generates at least one package for the at least one target device, each of the at least one package comprising respective signed data based on the at least one target unique device and on the firmware. For example, the package may include signed firmware, and the signature may include a hash of the combination of the target unique device ID and the firmware, or it may include a list of target unique device IDs. At 506, the firmware provider communicates the at least one package and the firmware to at least the at least one target unique device. In some embodiments, method 500 is performed by a firmware provider to distribute particular firmware to one or more particular authenticated devices.

The terms “an embodiment”, “embodiment”, “embodiments”, “the embodiment”, “the embodiments”, “one or more embodiments”, “some embodiments”, and “one embodiment” mean “one or more (but not all) embodiments” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments. Further, although process steps, method steps, algorithms or the like may be described in a sequential order, such processes, methods, and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments need not include the device itself.

At least certain operations that may have been illustrated in the figures show certain events occurring in a certain order. In alternative embodiments, certain operations may be performed in a different order, modified, or removed. Moreover, steps may be added to the above-described logic and still conform to the described embodiments. Further, operations described herein may occur sequentially or certain operations may be processed in parallel. Yet further, operations may be performed by a single processing unit or by distributed processing units.

The foregoing description of various embodiments has been presented for the purposes of illustration and description. It is not intended to be exhaustive or to be limited to the precise forms disclosed. Many modifications and variations are possible in light of the above teaching.

What is claimed is:

1. A method for authenticating a device associated with an immutable unique device identification to install firmware on the device, the method comprising:
retrieving, using processing circuitry at the device, the unique device identification;
receiving, at the device, a package comprising signed data based on at least one target unique device identification and based on the firmware;
authenticating, using the processing circuitry, the device based on the signed data; and
in response to authenticating the device, using the processing circuitry to cause the firmware to be installed on the device.

2. The method of claim 1, wherein the package further comprises the firmware.

3. The method of claim 1, further comprising:
decrypting the signed data; and
hashing a combination of the firmware and the unique device identification, wherein:
the at least one target unique device identification comprises a single target unique device identification,
the decrypted signed data comprises a hash of a combination of the firmware and the single target unique device identification, and
authenticating the device based on the signed data comprises comparing the hash of the combination of the firmware and the target unique device identification with the hash of the combination of the firmware and the unique device identification.

4. The method of claim 3, wherein the signed data is encrypted and decrypted using a digital signature scheme.

5. The method of claim 1, further comprising:
decrypting the signed data; and
identifying the at least one target unique device identification from the decrypted signed data, wherein authenticating the device based on the signed data comprises comparing the at least one target unique device identification to the unique device identification.

6. The method of claim 5, wherein the signed data is encrypted and decrypted using a digital signature scheme.

7. The method of claim 1, wherein the package further comprises data indicative of at least one of a type of the firmware or a configuration of the device.

8. A device, comprising processing circuitry configured to:
retrieve an immutable unique device identification;
receive a package comprising signed data based on at least one target unique device identification and based on the firmware;
authenticate the device based on the signed data; and
in response being authenticated, use processing circuitry to cause the firmware to be installed on the device.

9. The device of claim 8, wherein the package further comprises the firmware, wherein the processing circuitry is further configured to receive a package comprising firmware.

10. The device of claim 8, wherein:
the at least one target unique device identification comprises a single target unique device identification; and
the signed data comprises a hash of a combination of the firmware and the single target unique device identification,
wherein the processing circuitry is further configured to:
decrypt the signed data,
hash a combination of the firmware and the unique device identification, and
authenticate the device based on comparing the hash of the combination of the firmware and the target unique device identification with the hash of the combination of the firmware and the unique device identification.

11. The device of claim 10, wherein the signed data is encrypted using a digital signature scheme, wherein the processing circuitry is further configured to decrypt the signed data using a digital signature scheme.

12. The device of claim 8, wherein the processing circuitry is further configured to:
decrypt the signed data;
identify the at least one target unique device identification from the decrypted signed data; and
authenticate the device based on comparing the at least one target unique device identification to the unique device identification.

13. The device of claim 12, wherein the signed data is encrypted using a digital signature scheme, wherein the processing circuitry is further configured to decrypt the signed data using a digital signature scheme.

14. The device of claim 8, wherein the package further comprises data indicative of at least one of a type of the firmware or a configuration of the device, wherein the processing circuitry is further configured to receive a package comprising data indicative of at least one of a type of the firmware or a configuration of the device.

15. A method for distributing firmware to at least one target device, the method comprising:
determining for each of the at least one target device, a respective target unique device identification;
generating at least one package for the at least one target device, each of the at least one package comprising respective signed data based on the at least one target unique device identification and on the firmware; and
communicating the at least one package and the firmware to at least the at least one target device.

16. The method of claim 15, wherein each of the at least one package further comprises the firmware.

17. The method of claim 15, wherein:
determining each respective target unique device identification comprises retrieving each respective target unique device identification from each respective target unique device; and
generating each of the at least one package comprises hashing a combination of the firmware and a respective one of the at least one target unique device identification.

18. The method of claim 15, further comprising encrypting each of the at least one package.

19. The method of claim 18, wherein encrypting each of the at least one packages comprises encrypting each of the at least one packages using a digital signature scheme.

20. The method of claim 15, wherein each of the at least one package further comprises data indicative of at least one of a type of the firmware or a configuration of the device.
